(19) United States
(12) Patent Application Publication
(10) Pub. No.: US 2023/0244987 A1
(43) Pub. Date: Aug. 3, 2023

(54) ACCELERATED DATA LABELING WITH AUTOMATED DATA PROFILING FOR TRAINING MACHINE LEARNING PREDICTIVE MODELS

(71) Applicant: Capital One Services, LLC, McLean, VA (US)

(72) Inventors: Anh TRUONG, Champaign, IL (US); Austin WALTERS, Savoy, IL (US); Jeremy GOODSITT, Champaign, IL (US)

(21) Appl. No.: 17/649,633

(22) Filed: Feb. 1, 2022

(51) Int. Cl. G06N 20/00

(52) U.S. Cl. CPC G06N 20/00

(57) ABSTRACT

In some implementations, a data labeling system may receive unlabeled data samples and inputs to apply user-specified labels to data elements in a first subset of the unlabeled data samples. The data labeling system may identify a second subset of the unlabeled data samples including data elements with a structural similarity to the data elements in the first subset of the unlabeled data samples using a first machine learning model. The data labeling system may apply automatic labels to the data elements included in the second subset of the unlabeled data samples using the first machine learning model. The data labeling system may generate a labeled dataset that includes the data elements associated with the user-specified labels and the data elements associated with the automatic labels. Accordingly, in some implementations, the labeled dataset may be used to train a second machine learning model.

### BACKGROUND

Machine learning involves computers learning from data to perform tasks. Machine learning algorithms are used to train machine learning models based on sample data, known as “training data.” Once trained, machine learning models may be used to make predictions, decisions, or classifications relating to new observations. Machine learning algorithms may be used to train machine learning models for a wide variety of applications, including computer vision, natural language processing, financial applications, medical diagnosis, and/or information retrieval, among many other examples.

### SUMMARY

Some implementations described herein relate to a system for generating labeled datasets for training machine learning models. The system may include one or more memories and one or more processors communicatively coupled to the one or more memories. The one or more processors may be configured to receive, from one or more data sources, unlabeled data samples. The one or more processors may be configured to receive inputs to apply user-specified labels to data elements included in a first subset of the unlabeled data samples. The one or more processors may be configured to identify a second subset of the unlabeled data samples including data elements associated with a data profile indicating a structural similarity to the data elements included in the first subset of the unlabeled data samples. The one or more processors may be configured to apply automatic labels to the data elements included in the second subset of the unlabeled data samples using the first machine learning model. The one or more processors may be configured to generate a labeled dataset that includes the data elements associated with the user-specified labels and the data elements associated with the automatic labels. The one or more processors may be configured to train a second machine learning model using the labeled dataset.

Some implementations described herein relate to a method for generating a labeled dataset using automated data profiling. The method may include receiving, by a data labeling system, unlabeled data samples. The method may include receiving, by the data labeling system, inputs to apply user-specified labels to data elements included in a first subset of the unlabeled data samples. The method may include identifying, by the data labeling system, a second subset of the unlabeled data samples including data elements associated with a data profile indicating a structural similarity to the data elements included in the first subset of the unlabeled data samples, where the second subset of the unlabeled data samples is identified using a first machine learning model that is trained based on the user-specified labels. The method may include applying, by the data labeling system, automatic labels to the data elements included in the second subset of the unlabeled data samples using the first machine learning model. The method may include generating, by the data labeling system, a labeled dataset that includes the data elements associated with the user-specified labels and the data elements associated with the automatic labels.

Some implementations described herein relate to a non-transitory computer-readable medium that stores a set of instructions. The set of instructions, when executed by one or more processors of a data labeling system, may cause the data labeling system to receive, from one or more data sources, unlabeled data samples. The set of instructions, when executed by the one or more processors of the data labeling system, may cause the data labeling system to receive inputs to apply user-specified labels to data elements included in a first subset of the unlabeled data samples. The set of instructions, when executed by the one or more processors of the data labeling system, may cause the data labeling system to identify a second subset of the unlabeled data samples including data elements associated with a data profile indicating a structural similarity to the data elements included in the first subset of the unlabeled data samples. The set of instructions, when executed by the one or more processors of the data labeling system, may cause the data labeling system to apply automatic labels to the data elements included in the second subset of the unlabeled data samples using the first machine learning model. The set of instructions, when executed by the one or more processors of the data labeling system, may cause the data labeling system to present a user interface to request feedback related to the automatic labels based on confidence levels associated with the automatic labels. The set of instructions, when executed by the one or more processors of the data labeling system, may cause the data labeling system to generate, based on the feedback related to the automatic labels, a labeled dataset that includes the data elements associated with the user-specified labels and the data elements associated with the automatic labels.

### BRIEF DESCRIPTION OF THE DRAWINGS

FIGS. 1A-1B are diagrams of an example implementation related to accelerated data labeling with automated data profiling for training machine learning predictive models.

FIG. 2 is a diagram illustrating an example of training a machine learning model in connection with accelerated data labeling for training machine learning predictive models.

FIG. 3 is a diagram illustrating an example of applying a trained machine learning model to a new observation associated with data labeling for training machine learning predictive models.

FIG. 4 is a diagram of an example environment in which systems and/or methods described herein may be implemented.

FIG. 5 is a diagram of example components of one or more devices of FIG. 4.

FIG. 6 is a flowchart of an example process related to accelerated data labeling with automated data profiling for training machine learning predictive models.

### DETAILED DESCRIPTION

The following detailed description of example implementations refers to the accompanying drawings. The same reference numbers in different drawings may identify the same or similar elements.

In machine learning, data labeling refers to processes to identify raw unlabeled data samples (e.g., text files, images, audio clips, and/or videos, among other examples) and add one or more meaningful and informative labels to provide context that can be used to train machine learning predictive models. In general, data labeling is needed for various machine learning use cases, including computer vision, natural language processing, and speech recognition. For example, in a computer vision use case, a label may indicate whether an image contains a bird, a car, a person, or another object, or may indicate whether a medical image contains a tumor or a fracture, among other examples. In another example, in a natural language processing or speech recognition use case, a label may indicate which words were uttered in an audio recording and/or a context associated with one or more utterances, among other examples. Accordingly, because machine learning models often use supervised learning to apply one or more algorithms to map one or more inputs (e.g., observations or features) to one or more outputs (e.g., target variables), a labeled dataset that includes a large volume of high-quality training data is needed to train the machine learning models to make correct decisions. However, existing techniques to create labeled datasets that are needed to train machine learning models are typically expensive, complicated, time-consuming, and/or error-prone, among other drawbacks.

For example, data labeling is typically a manual process driven by human labelers making judgments about a given piece of unlabeled data, which may be referred to herein as an unlabeled data sample. For example, in an object recognition application, the human labelers may be tasked with tagging or otherwise labeling all images in a dataset to indicate whether each respective image contains a particular object, where the labeling can be coarse (e.g., a Boolean or binary value that indicates whether the object is or is not present in the image) or granular (e.g., identifying a region or specific pixels in the image that depict the object). Accordingly, in a typical data labeling process, human personnel are responsible for manually labeling data samples in a way that allows a machine learning model to learn how to make correct decisions, and the machine learning model then uses the human-provided manual labels to learn underlying patterns in a process known as model training, which results in a trained machine learning model that can be used to make predictions on new data. However, manual labeling by human personnel can result in low-quality labels due to various factors, such as a cognitive load and context switching for human labelers, error or bias caused by fatigue and/or insufficient domain knowledge or contextual understanding of individual labelers, and/or difficulties identifying and resolving inconsistencies or inaccuracies in a large-volume labeled dataset. Furthermore, manual labeling is very time-consuming due to large volumes of unlabeled data samples and significant variations in data structures that are used in the unlabeled data samples. In addition, to the extent that there have been efforts to make data labeling more efficient by using active learning, such learning techniques are limited to identifying the most useful data samples to be labeled by humans. Furthermore, for certain applications such as sensitive data detection to mask and/or delete sensitive information (e.g., personally identifiable information (PII)), available data sources are limited, which reduces the quality of data classifiers or any predictive models.

Some implementations described herein relate to techniques to accelerate a process to generate a labeled dataset that can be used to train a machine learning predictive model. In some implementations, a data labeling system may present an initial set of unlabeled data samples to one or more users (e.g., human labelers), and the data labeling system may receive, from the one or more users, inputs to apply manual labels to the unlabeled data samples. For example, in some implementations, the one or more users may review the unlabeled data samples and add one or more labels to certain text, fields, lines, rows, columns, sections, or other suitable data elements included in the unlabeled data samples. In some implementations, the data labeling system may then use one or more data profilers to detect a structure or other attributes associated with the manually labeled data samples, where the one or more data profilers may include or may use one or more machine learning models that are trained to identify other data samples with a similar structure as the manually labeled data samples. In some implementations, the data labeling system may automatically label the data samples that have the similar structure as the manually labeled data samples, and may use the automatic labels to augment the manual labels input by the one or more users. Furthermore, in some implementations, the data labeling system may assign confidence values to the automatic labels, which may be used to manage the manual and/or automatic labels. For example, in cases where the confidence values are high (e.g., satisfy a threshold), the data labeling system may keep the automatic labels without informing any users. However, in cases where the confidence values are low (e.g., fail to satisfy a threshold), the data labeling system may present the automatic labels to one or more users and prompt the one or more users to review the automatic labels. For example, when the users confirm that the automatic labels are correct, the data labeling system may keep the correct automatic labels and reinforce one or more rules that are used to predict a label to be automatically applied to new data samples with a similar structure or data profile. Alternatively, in cases where the users indicate that the automatic labels are incorrect, the incorrect automatic labels may be replaced with user-provided labels and one or more counter-rules may be defined or reinforced to prevent the same or similar labeling errors from occurring on new data samples. Furthermore, in some implementations, the data labeling system may perform other techniques to improve the efficiency and accuracy of labeled data, such as automated auditing to identify and/or update manually and/or automatically labeled data samples with a low confidence.

In this way, by using automated data profiling and automated labeling to reduce the reliance on human users to label data samples, some implementations described herein may significantly reduce the time that is expended to process all the data samples that need to be labeled to create a labeled data set (e.g., because the automated data labeling system is not constrained by human factors such as fatigue, cognitive processing speed, and/or the work that a person can complete in a labeling session). For example, according to some estimates, around 80% of artificial intelligence project time is spent gathering, organizing, and labeling data, whereby using automated data profiling and automated labeling to reduce the reliance on human labelers may accelerate the process to create a high-quality dataset that is structured and labeled in a way that can be used to train and deploy machine learning predictive models. Furthermore, the automated data profiling and automated labeling may be implemented using continuous feedback and learning (e.g., defining and reinforcing rules based on whether manual and/or automatic labels are deemed correct or incorrect), which may significantly reduce errors or biases that may be introduced in data labeling approaches that rely solely on human labelers.

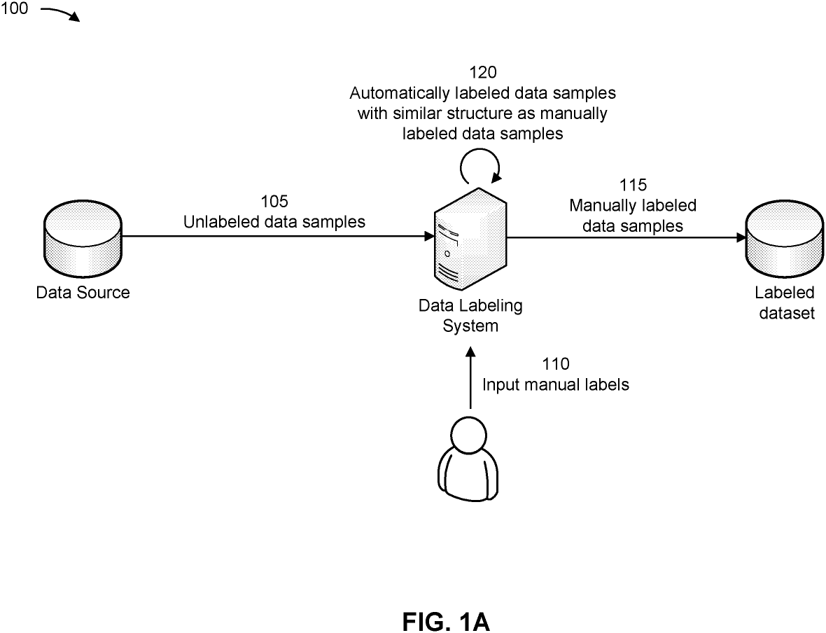

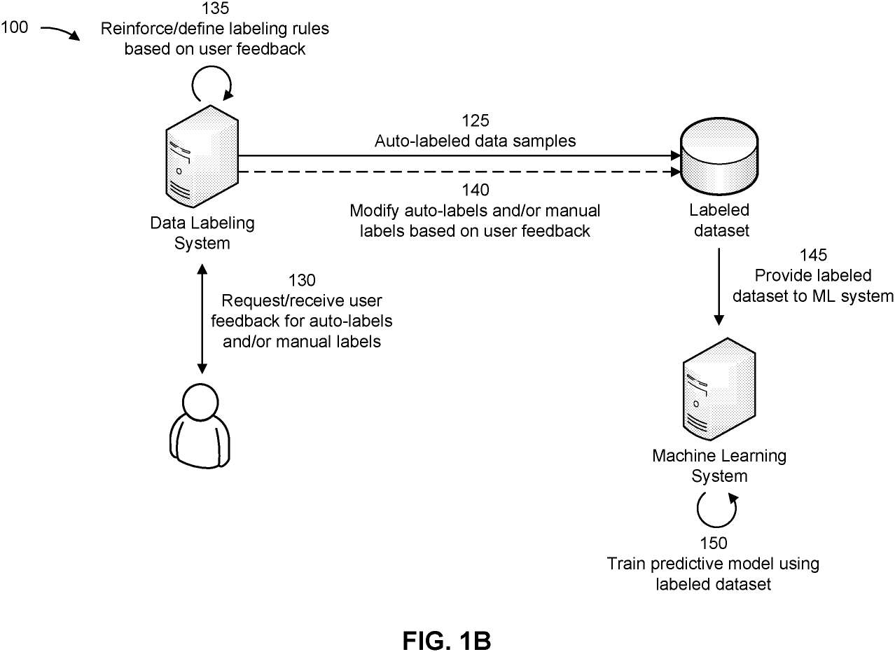

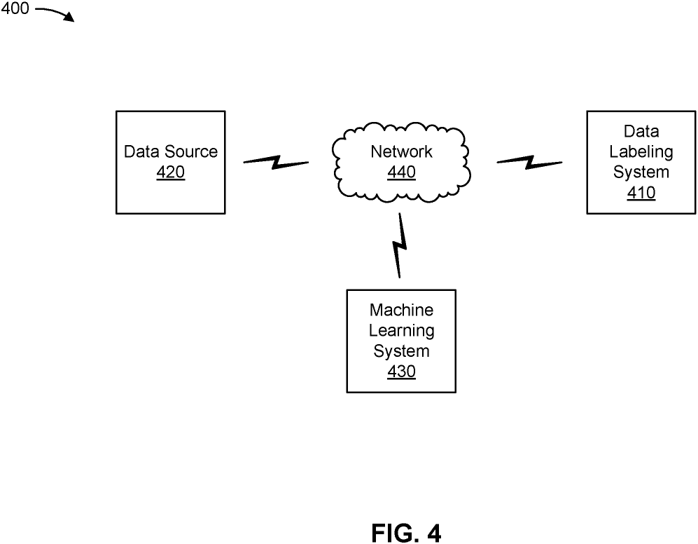

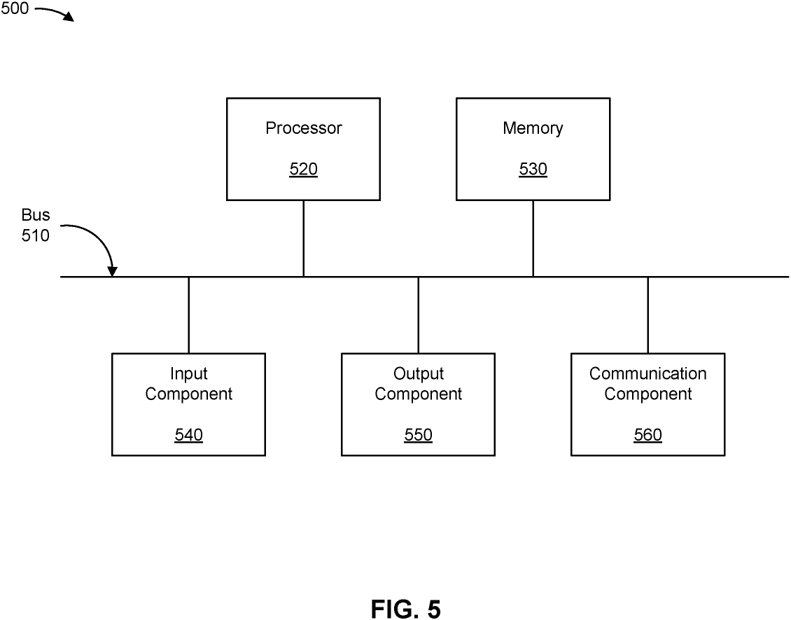

FIGS. 1A-1B are diagrams of an example implementation 100 related to accelerated data labeling with automated data profiling for training machine learning predictive models. As shown in FIGS. 1A-1B, example implementation 100 includes a data labeling system, a data source, and a machine learning system. As further shown, the data labeling system may include one or more data repositories that may be used to store one or more labeled data sets. Furthermore, as described herein, the data labeling system may include or may communicate with a client device or a user device (not explicitly shown) that may allow one or more users to interact with the data labeling system. The data labeling system, the data source, and the machine learning system are described in more detail in connection with FIG. 4 and FIG. 5.

In some implementations, the data labeling system may use automated data profiling and automated labeling in combination with manual labeling and partial user supervision to generate one or more labeled datasets that can be used to train one or more machine learning predictive models. For example, as described herein, the data labeling system may be used to generate a labeled dataset that can be used to train a machine learning model to detect and mask sensitive data in one or more data sources. For example, sensitive data elements may include personally identifiable information (PII), such as national identification numbers (e.g., social security numbers (SSNs) in the United States, social insurance numbers (SINs) in Canada, SSNs in the Philippines, permanent account numbers (PANs) in India, national insurance numbers (NINOs) in the United Kingdom, employer identification numbers (EINs) in the United States, individual taxpayer identification numbers (ITINs) in the United States, tax identification numbers (TINs) in Costa Rica, and/or other unique or quasi-unique identification numbers), credit card numbers, bank account numbers, passport numbers, driver’s license numbers, and/or other PII. In general, to protect PII against exposure in a potential data breach, sensitive data elements should either be encrypted or masked when stored. For example, a machine learning model may be trained to detect sensitive data elements such that one or more alphanumeric characters in the sensitive data elements may be replaced with “X”s or other characters to prevent the sensitive data elements from being stored or exposed in the event that a data breach occurs (e.g., an SSN may be stored as “XXX-XX-XXXX”). Additionally, or alternatively, the sensitive data elements that are detected using the machine learning model may be deleted from data records to prevent the sensitive data elements from being stored or exposed in a data breach.

In order to correctly detect and mask or delete sensitive data elements, the machine learning model may need to be trained to predict whether a data element includes sensitive information using a labeled dataset, which may be partitioned into one or more training datasets, one or more test datasets, and/or one or more validation datasets, as described in more detail elsewhere herein. In such cases, the sensitive data elements may typically have a text-based format, where there may be various different text-based data formats, data structures, data schemas, and/or other suitable data representations and large text volumes with potentially sensitive data elements. Accordingly, some implementations are described herein in a context that relates to accelerated data labeling using automated data profiling to generate a labeled dataset that includes text-based data elements to aid in training a machine learning model to detect sensitive data elements to be masked, deleted, or otherwise obfuscated. However, it will be appreciated that sensitive data detection is merely an example machine learning application that may be enabled by the data labeling system described herein, and that the techniques described herein may be applied to generate labeled datasets for other applications (e.g., computer vision, natural language processing, and/or sound categorization, among other examples) and/or may be applied to generate labeled datasets including text-based data samples or other types of data samples (e.g., audio, images, and/or video, among other examples).

As shown in FIG. 1A, and by reference number 105, the data labeling system may receive, from the one or more data sources, unlabeled data samples that may include structured data and/or unstructured data. For example, in cases where the unlabeled data samples include structured data, the unlabeled data samples may have a standardized format and clearly defined schemas, data structures, and/or data types, which are typically organized into rows and columns that can be mapped to specific fields and easily searched. For example, the one or more data sources may store the structured data in one or more relational databases in which data fields may store length-delineated data elements (e.g., phone numbers, SSNs, zip codes, credit card numbers, or other data elements have a fixed length) and/or text strings with a variable length (e.g., names, addresses, and/or product names). Accordingly, in some implementations, the unlabeled data samples may include structured data with text-based data elements having clearly defined data types and predefined data models. However, despite the fact that structured data is associated with clearly defined data types and predefined data models, there may be significant variations in the data structures, schemas, data types, and/or formats associated with the structured data. For example, the structured data received from the one or more data sources may include data elements associated with the JavaScript Object Notation (JSON) format, which uses human-readable text to store and transmit data objects that include attribute-value pairs and arrays or other serializable data values. Additionally, or alternatively, the structured data may be associated with a comma-separated value (CSV) format, which is a delimited text-based format in which tabular data is stored as plain text data with commas used as delimiters to separate different data fields. Accordingly, as described herein, text that may potentially include sensitive data elements may be represented in structured data associated with different formats that may have significant variations in data structures.

Furthermore, in cases where the unlabeled data samples include unstructured data (e.g., text, images, sound, video, or other data with no predefined data model), the unstructured data may lack an orderly internal structure that can be used to label or otherwise categorize text that may include sensitive information to be masked, deleted, or otherwise obfuscated. For example, unstructured data that may include sensitive (text-based) information may include raw text or plain text files, word processing documents, presentation documents, email messages, and/or text messages, among other examples. Furthermore, unstructured data that may include sensitive information is not limited to text formats, as sensitive data may be included in audio clips (e.g., a recording in which one or more utterances indicate a bank account number, a password, or other sensitive information), images (e.g., a picture of a driver’s license, vaccination card, and/or a scanned document), and/or video files in which sensitive data may be included in sound and/or one or more frames, among other examples. Accordingly, sensitive data may generally be present in structured data and/or unstructured data, which may represent the sensitive data using a wide variation in data structures, data formats, data schemas, and/or data types. As described in further detail herein, the data labeling system may accelerate a process to tag, annotate, or otherwise label the unlabeled data samples that are obtained from the one or more data sources in order to generate a labeled dataset that can be used to train a machine learning model to predict whether a given data element is sensitive or non-sensitive.

As further shown in FIG. 1A, and by reference number 110, the data labeling system may receive inputs to apply manual labels to an initial subset of the unlabeled data samples from one or more users. In some implementations, the data labeling system may receive the inputs via one or more client devices that are included in or in communication with the data labeling system. For example, when the data labeling system is used to generate a labeled dataset to train a machine learning model to detect sensitive data elements, the inputs received from the users may include tags, annotations, metadata, or other suitable information to indicate a type of information that is conveyed by a data field or text string. In some implementations, the data labeling system may generate user interfaces to present unlabeled data elements to the one or more users, and the one or more users may provide inputs indicating one or more manual labels to be associated with each data element. For example, structured data may be presented to the one or more users as one or more lines or rows, each corresponding to a data record, with each column representing a different field of the data record. Accordingly, the users may indicate a manual label to apply to each column in the structured data, such as whether the data fields in a particular column includes names, street addresses, zip codes, phone numbers, bank account numbers, passport numbers, national identification numbers, credit card numbers, card verification values, transaction values, merchant names, account balances, and/or Internet Protocol (IP) addresses, among other examples. Furthermore, when defining a new label to tag or annotate a particular data type, the users may further indicate whether the new label is a sensitive data type or a non-sensitive data type.

Furthermore, the users may take a similar approach to apply manual labels to unstructured data. For example, the users may highlight or otherwise select text included in one or more unstructured data samples, and may indicate the data type associated with the selected text. In another example, to label text included in images or frames of video, the users may draw bounding boxes around the text, transcribe the text manually or using optical character recognition (OCR) or another suitable technique, and indicate the label and/or sensitivity of the labeled text. Similarly, to label sensitive data in an audio clip, the audio clip may be transcribed to text (e.g., manually or using an automated transcription service) that is associated with timestamps or other information to indicate the location of the corresponding utterance(s) in the audio clip, and the users may then manually label the text to indicate the data type and/or sensitivity of the data type.

In some implementations, the data labeling system may utilize one or more techniques to improve the efficiency and/or quality of the manual labels that are input by the one or more users. For example, in some implementations, the data labeling system may generate user interfaces that are intuitive and streamline the manual labeling task to help minimize a cognitive load and context switching that needs to be performed by manual labelers (e.g., providing access to domain knowledge to help with the labeling task and providing clear and easy-to-read interfaces that allow users to discern patterns quickly and accurately). Additionally, or alternatively, the data labeling system may implement a labeling consensus feature, where each unlabeled data sample to be labeled is sent to multiple human labelers whose tags, annotations, or other responses may be consolidated into a single label to help counteract errors or biases that may be introduced by different labelers acting individually. Additionally, or alternatively, the data labeling system may use one or more machine learning models that are trained to select the subset of the unlabeled data samples to be manually labeled in order to generate the initial set of manual labels more efficiently. For example, in some implementations, the one or more machine learning models may select unlabeled data samples in a way that ensures that the manually labeled data samples cover all or a large portion of the different data structures, data formats, and/or data schemas that are used in the one or more data sources. For example, the machine learning models may be trained to identify a diverse subset of unlabeled data samples that includes different unstructured data types (e.g., raw text files, audio clips, word processing documents, images, and/or email messages) and structured data with different formats (e.g., JSON, CSV, and/or extensible markup language (XML), among other examples).

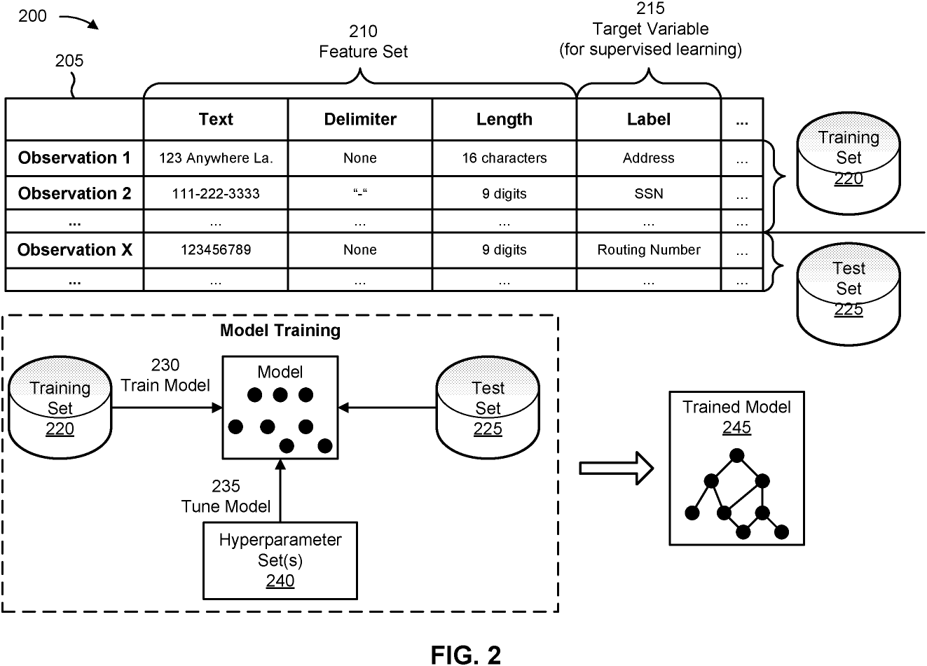

Accordingly, as further shown in FIG. 1A, and by reference number 115, the data labeling system may store the manually labeled data samples in a suitable data repository. In some implementations, the manually labeled data samples may be used as training data for one or more machine learning models that can be used to identify data profiles associated with the manually labeled data samples and select additional unlabeled data samples that have a similar structural profile (e.g., such that the data labeling system can automatically label the additional unlabeled data samples using the manual labels that were initially defined by the one or more users). For example, in some implementations, the manually labeled data samples may be used as observations to train the machine learning model(s) to predict a data profile, which may be partitioned into a training dataset, a test dataset, and/or other suitable datasets and used to train the machine learning model(s) to perform a data profiling function (e.g., using techniques described in more detail below with reference to FIG. 2).

As further shown in FIG. 1A, and by reference number 120, the data labeling system may automatically label one or more additional subsets of the unlabeled data samples that are associated with a similar structure as the manually labeled data samples. For example, in some implementations, the data labeling system may detect the labels applied to the manually labeled data samples by the one or more users and may determine data profiles associated with the manually labeled data samples. For example, the data labeling system may identify the structure, data type, data schema, and/or data format associated with labeled and/or unlabeled data samples using one or more data profilers, which may include programs or other suitable code configured to retrieve, store, and/or analyze properties of data models, datasets, data samples, and/or data elements. For example, a data profiler may include or may be configured to implement one or more data profiling models, where the data profiling models may include machine learning models and/or statistical models (e.g., a recurrent neural network (RNN), a convolutional neural network (CNN), or another suitable machine learning model) to determine a data schema and/or a statistical profile of a dataset, a data sample, and/or a data element.

For example, in some implementations, the data profilers used by the data labeling system may include one or more algorithms to determine a data type, key value pairs, a row-column data structure, a statistical distribution of information such as keys or values, or other properties of a data schema. Accordingly, the data profiles may return a statistical profile of a dataset or a data sample based on the properties of the data schema. In some implementations, the data profilers may be configured to implement univariate and/or multivariate statistical methods to determine the statistical profiles of the datasets and/or data samples. For example, the data profilers may include a regression model, a Bayesian model, a statistical model, a linear discriminant analysis model, or other classification model configured to determine one or more descriptive metrics or other attributes of a dataset or a data sample (e.g., an average, a mean, a standard deviation, a quantile, a quartile, a probability distribution function, a range, a moment, a variance, a covariance, a covariance matrix, a dimension and/or dimensional relationship, or any other descriptive metric of a dataset or a data sample). Accordingly, in some implementations, the data labeling system may use the data profilers to determine a data profile that includes one or more attributes related to a structure (e.g., a schema, a data type, a range of values) of a dataset or a data sample using a machine learning data profiling model. For example, the data profile may include a statistical profile based on multiple descriptive metrics or attributes, such as an average, a mean, a standard deviation, a range, a moment, a variance, a covariance, a covariance matrix, a similarity metric, or any other statistical metric or attribute related to structure of a selected dataset or a selected data sample.

Additionally, or alternatively, the attributes that are represented in a data profile may include one or more patterns for a particular data type. For example, in a sensitive data detection application, the one or more patterns may indicate that SSNs correspond to a pattern of three numbers, two numbers, and four numbers that may be separated by delimiting characters (e.g., “###-##-####” or “### ## ####” or “#########”, where the first example includes a dash for a delimiting character, the second example includes a blank space for a delimiting character, and the last example includes no delimiting characters). In another example, the one or more patterns may indicate that employer identification numbers (EINs) correspond to a pattern of two numbers followed by seven numbers, with one or three additional characters (e.g., “##-#######” or “##-#######A” or “##-####### ###”). In yet other examples, the one or more patterns may indicate that bank account numbers follow a pattern often numbers or twelve numbers (e.g., “##########” or “############”), that routing numbers follow a pattern of nine numbers (e.g., “#########”), and/or that addresses follow a pattern of a house or building number followed by a street name (e.g., “### {STREET}”), among other examples.

Accordingly, in some implementations, the data labeling system may use the data profilers to generate statistical profiles, patterns, and/or other information to profile the manually labeled data samples and to identify other unlabeled data samples that are structurally similar to the manually labeled data samples. For example, the data profilers may be configured to classify datasets and/or data samples, which may include determining whether an unlabeled dataset or an unlabeled data sample is related to a dataset or a data sample that was manually labeled. In some implementations, classifying a dataset or a data sample may include clustering the dataset or data sample and generating information to indicate whether the dataset or data sample belongs to a cluster of datasets or data samples. In some implementations, classifying a dataset or a data sample may include generating data describing the dataset or data sample (e.g., an index), including metadata, an indicator of whether the dataset or data sample includes actual data and/or synthetic data, a data schema, a statistical profile, a relationship between the dataset or data sample and one or more reference datasets or data samples (e.g., node and edge data), and/or other descriptive information. In this way, the data labeling system may use the one or more data profilers to automate a process to identify unlabeled data samples that have a structural similarity to the manually labeled data samples such that the unlabeled data samples can be automatically labeled using one or more of the previously defined manual labels.

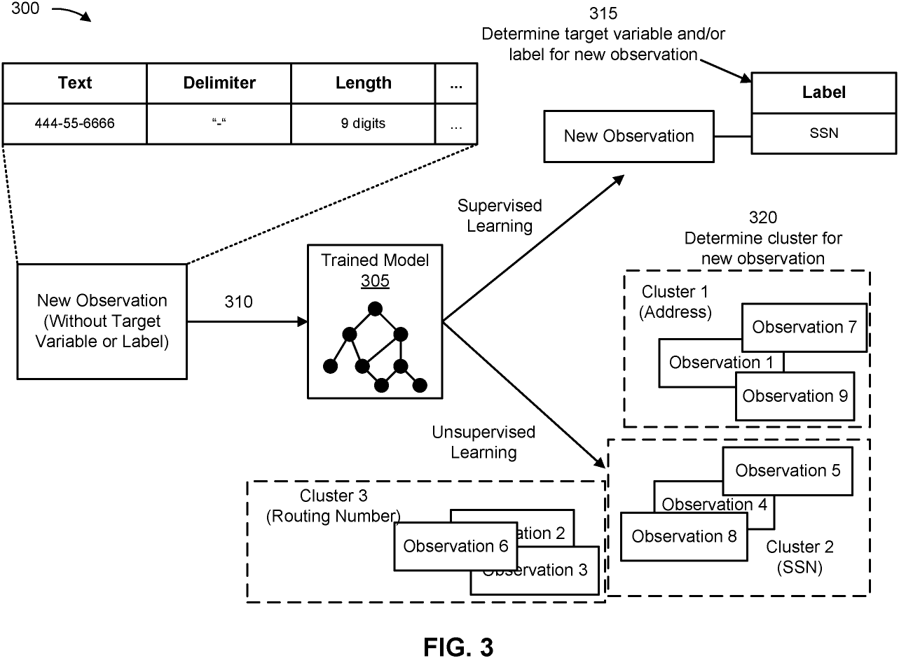

Accordingly, as shown in FIG. 1B, and by reference number 125, the data labeling system may apply automatic labels to the data elements included in the unlabeled data samples that are structurally similar to the manually labeled data samples, and the automatically labeled data samples may be added to the labeled dataset in the appropriate data repository. For example, in some implementations, the data labeling system may use the machine learning models (e.g., data profilers) to determine the automatic labels to be applied based on the manually labeled data samples that are structurally similar to the unlabeled data samples that are automatically labeled (e.g., using the machine learning techniques described in further detail below with reference to FIG. 3). Furthermore, when automatically labeling data samples, the data labeling system may determine a confidence level for each automatic label, and the data labeling system may use the confidence level to determine whether to solicit user feedback for the automatic labels. For example, in cases where the confidence level associated with an automatic label satisfies a threshold (e.g., based on the values in a first field and a second field being consistent on data types, having a unique length, or a variation that is within a threshold), the data labeling system may maintain the automatic label without notifying users. Alternatively, in cases where the confidence level associated with an automatic label fails to satisfy the threshold, the data labeling system may solicit user feedback to confirm, update, or otherwise audit the automatic labels and/or any impacted manual labels that were previously applied.

In particular, as further shown in FIG. 1B, and by reference number 130, the data labeling system may request and receive feedback from one or more users for automatic labels and/or manual labels that are associated with a confidence level that fails to satisfy a threshold. For example, as described above, the data labeling system may determine a confidence level for each automatic label, and the data labeling system may further determine confidence levels for the previously defined manual labels based on the same or similar data profiling techniques that are used to generate the automatic labels (e.g., the data labeling system may predict the label(s) to be applied to a manually labeled data sample using the trained machine learning model(s), and may assign a confidence level to the manually labeled data sample based on whether the predicted label(s) match the user-defined manual label(s)). In this way, the data labeling system may be used to solicit feedback to confirm or correct automatic labels that are associated with a low confidence level and to audit and correct previously defined manual labels that may be incorrect. In some implementations, when requesting the user feedback for the automatic and/or manual labels associated with a low confidence level, the data labeling system may present the labels to be reviewed via one or more user interfaces that provide an intuitive and streamlined approach to resolving any discrepancies. For example, in some implementations, the labels to be reviewed by the one or more users may be highlighted or emphasized (e.g., using different visual indicators to differentiate automatic labels for which feedback is requested, such as a first color for data elements labeled as addresses, a second color for data elements labeled as phone numbers, and so on). In this way, the user interfaces may be designed to significantly reduce the time and/or error involved in manually reviewing all of the content of the data samples that are associated with labels of questionable quality or veracity.

As further shown in FIG. 1B, and by reference number 135, the data labeling system may reinforce and/or define one or more labeling rules based on the feedback received from the one or more users. For example, in cases where the user feedback indicates that an automatic label or a manual label with a low confidence level is correct, the data labeling system may reinforce one or more labeling rules that resulted in the data sample being tagged with the automatic or manual associated with the low confidence level. In this way, the machine learning models that the data labeling system uses to apply automatic labels to additional data samples may become more accurate over time, and may learn to correctly predict variations in different data types (e.g., accounting for regional variations in address formats, national identification number formats, telephone numbers, and/or other suitable data fields). On the other hand, in cases where the user feedback indicates that an automatic label or a manual label with a low confidence level is incorrect, the user feedback may further indicate the correct label to be applied, and the data labeling system may define or update one or more counter-rules to reduce a probability that the same labeling mistake will be made again in the future. In this way, the machine learning models that the data labeling system uses to apply automatic labels may continually learn from the user feedback that indicates whether the automatic labels and/or manual labels were correctly applied such that accuracy and confidence in the labeling improves over time. Furthermore, as shown by reference number 140, the data labeling system may modify one or more automatic labels and/or one or more manual labels based on the user feedback. For example, any labels that were identified as incorrect may be updated with the correct user-defined label, and the data labeling system may further analyze other automatic and/or manuals in the labeled dataset that may be impacted by the labeling rules that were reinforced, defined, and/or updated based on the user feedback. In this way, the user feedback may be used to improve the overall quality and reliability of the labeled dataset.

Accordingly, as further shown in FIG. 1B, and by reference number 145, the data labeling system may continue to apply automatic labels to unlabeled data samples and/or audit previously applied automatic and/or manual labels until the labeled dataset has a sufficient quality and a sufficient volume that allows for training a machine learning predictive model, at which time the labeled dataset may be provided to a machine learning system. For example, as described in further detail below with reference to FIG. 2 and/or FIG. 3, the data labeling system may label data samples until the labeled dataset satisfies one or more conditions (e.g., is associated with a cross-validation score that satisfies a threshold) indicating that the labeled dataset is ready to be used to train a machine learning predictive model. As further shown in FIG. 1B, and by reference number 150, the machine learning system may then use the labeled dataset to train the appropriate machine learning predictive model. For example, as described herein, the labeled dataset may be used to indicate whether certain data fields or data types include sensitive data, whereby the machine learning system may use the labeled dataset to train a machine learning model to detect sensitive data (e.g., PII) that needs to be masked, deleted, concealed, or otherwise obfuscated to protect the underlying data against unauthorized disclosure.

As indicated above, FIGS. 1A-1B are provided as an example. Other examples may differ from what is described with regard to FIGS. 1A-1B.

FIG. 2 is a diagram illustrating an example 200 of training a machine learning model in connection with accelerated data labeling for training machine learning predictive models. The machine learning model training described herein may be performed using a machine learning system. The machine learning system may include or may be included in a computing device, a server, a cloud computing environment, or the like, such as the data labeling system and/or the machine learning system shown in FIGS. 1A-1B, as described in more detail elsewhere herein.

As shown by reference number 205, a machine learning model may be trained using a set of observations. The set of observations may be obtained and/or input from training data (e.g., historical data), such as data gathered during one or more processes described herein. For example, the set of observations may include data gathered from a data labeling system that is used to generate a labeled dataset based on a combination of manual labeling, automatic labeling, and user feedback, as described elsewhere herein. In some implementations, the machine learning system may receive the set of observations (e.g., as input) from the data labeling system.

As shown by reference number 210, a feature set may be derived from the set of observations. The feature set may include a set of variables. A variable may be referred to as a feature. A specific observation may include a set of variable values corresponding to the set of variables. A set of variable values may be specific to an observation. In some cases, different observations may be associated with different sets of variable values, sometimes referred to as feature values. In some implementations, the machine learning system may determine variables for a set of observations and/or variable values for a specific observation based on input received from the data labeling system. For example, the machine learning system may identify a feature set (e.g., one or more features and/or corresponding feature values) from structured data input to the machine learning system, such as by extracting data from a particular column of a table, extracting data from a particular field of a form and/or a message, and/or extracting data received in a structured data format. Additionally, or alternatively, the machine learning system may receive input from an operator to determine features and/or feature values. In some implementations, the machine learning system may perform natural language processing and/or another feature identification technique to extract features (e.g., variables) and/or feature values (e.g., variable values) from text (e.g., unstructured data) input to the machine learning system, such as by identifying keywords and/or values associated with those keywords from the text.

As an example, a feature set for a set of observations may include a first feature of text, a second feature of delimiter, a third feature of length, and so on. As shown, for a first observation, the first feature may have a value of “123 Anywhere La.,” the second feature may have a value of “None,” the third feature may have a value of 16 characters, and so on. These features and feature values are provided as examples, and may differ in other examples. For example, the feature set may include one or more of the following features: data format (e.g., structured or unstructured, JSON or CSV, file type), pattern, and/or value range, among other examples. In some implementations, the machine learning system may pre-process and/or perform dimensionality reduction to reduce the feature set and/or combine features of the feature set to a minimum feature set. A machine learning model may be trained on the minimum feature set, thereby conserving resources of the machine learning system (e.g., processing resources and/or memory resources) used to train the machine learning model.

As shown by reference number 215, the set of observations may be associated with a target variable. The target variable may represent a variable having a numeric value (e.g., an integer value or a floating point value), may represent a variable having a numeric value that falls within a range of values or has some discrete possible values, may represent a variable that is selectable from one of multiple options (e.g., one of multiples classes, classifications, or labels), or may represent a variable having a Boolean value (e.g., 0 or 1, True or False, Yes or No), among other examples. A target variable may be associated with a target variable value, and a target variable value may be specific to an observation. In some cases, different observations may be associated with different target variable values. In example 200, the target variable is a label, which has a value of “Address” for the first observation.

The feature set and target variable described above are provided as examples, and other examples may differ from what is described above. For example, for a target variable of sensitivity, the feature set may include a data type (e.g., data types associated with PII may be associated with a target variable of sensitive, and other data types may be associated with a target variable of non-sensitive.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model or a predictive model. When the target variable is associated with continuous target variable values (e.g., a range of numbers), the machine learning model may employ a regression technique. When the target variable is associated with categorical target variable values (e.g., classes or labels), the machine learning model may employ a classification technique.

In some implementations, the machine learning model may be trained on a set of observations that do not include a target variable (or that include a target variable, but the machine learning model is not being executed to predict the target variable). This may be referred to as an unsupervised learning model, an automated data analysis model, or an automated signal extraction model. In this case, the machine learning model may learn patterns from the set of observations without labeling or supervision, and may provide output that indicates such patterns, such as by using clustering and/or association to identify related groups of items within the set of observations.

As further shown, the machine learning system may partition the set of observations into a training set 220 that includes a first subset of observations, of the set of observations, and a test set 225 that includes a second subset of observations of the set of observations. The training set 220 may be used to train (e.g., fit or tune) the machine learning model, while the test set 225 may be used to evaluate a machine learning model that is trained using the training set 220. For example, for supervised learning, the test set 225 may be used for initial model training using the first subset of observations, and the test set 225 may be used to test whether the trained model accurately predicts target variables in the second subset of observations. In some implementations, the machine learning system may partition the set of observations into the training set 220 and the test set 225 by including a first portion or a first percentage of the set of observations in the training set 220 (e.g., 75%, 80%, or 85%, among other examples) and including a second portion or a second percentage of the set of observations in the test set 225 (e.g., 25%, 20%, or 15%, among other examples). In some implementations, the machine learning system may randomly select observations to be included in the training set 220 and/or the test set 225.

As shown by reference number 230, the machine learning system may train a machine learning model using the training set 220. This training may include executing, by the machine learning system, a machine learning algorithm to determine a set of model parameters based on the training set 220. In some implementations, the machine learning algorithm may include a regression algorithm (e.g., linear regression or logistic regression), which may include a regularized regression algorithm (e.g., Lasso regression, Ridge regression, or Elastic-Net regression). Additionally, or alternatively, the machine learning algorithm may include a decision tree algorithm, which may include a tree ensemble algorithm (e.g., generated using bagging and/or boosting), a random forest algorithm, or a boosted trees algorithm. A model parameter may include an attribute of a machine learning model that is learned from data input into the model (e.g., the training set 220). For example, for a regression algorithm, a model parameter may include a regression coefficient (e.g., a weight). For a decision tree algorithm, a model parameter may include a decision tree split location, as an example.

As shown by reference number 235, the machine learning system may use one or more hyperparameter sets 240 to tune the machine learning model. A hyperparameter may include a structural parameter that controls execution of a machine learning algorithm by the machine learning system, such as a constraint applied to the machine learning algorithm. Unlike a model parameter, a hyperparameter is not learned from data input into the model. An example hyperparameter for a regularized regression algorithm includes a strength (e.g., a weight) of a penalty applied to a regression coefficient to mitigate overfitting of the machine learning model to the training set 220. The penalty may be applied based on a size of a coefficient value (e.g., for Lasso regression, such as to penalize large coefficient values), may be applied based on a squared size of a coefficient value (e.g., for Ridge regression, such as to penalize large squared coefficient values), may be applied based on a ratio of the size and the squared size (e.g., for Elastic-Net regression), and/or may be applied by setting one or more feature values to zero (e.g., for automatic feature selection). Example hyperparameters for a decision tree algorithm include a tree ensemble technique to be applied (e.g., bagging, boosting, a random forest algorithm, and/or a boosted trees algorithm), a number of features to evaluate, a number of observations to use, a maximum depth of each decision tree (e.g., a number of branches permitted for the decision tree), or a number of decision trees to include in a random forest algorithm.

To train a machine learning model, the machine learning system may identify a set of machine learning algorithms to be trained (e.g., based on operator input that identifies the one or more machine learning algorithms and/or based on random selection of a set of machine learning algorithms), and may train the set of machine learning algorithms (e.g., independently for each machine learning algorithm in the set) using the training set 220. The machine learning system may tune each machine learning algorithm using one or more hyperparameter sets 240 (e.g., based on operator input that identifies hyperparameter sets 240 to be used and/or based on randomly generating hyperparameter values). The machine learning system may train a particular machine learning model using a specific machine learning algorithm and a corresponding hyperparameter set 240. In some implementations, the machine learning system may train multiple machine learning models to generate a set of model parameters for each machine learning model, where each machine learning model corresponds to a different combination of a machine learning algorithm and a hyperparameter set 240 for that machine learning algorithm.

In some implementations, the machine learning system may perform cross-validation when training a machine learning model. Cross validation can be used to obtain a reliable estimate of machine learning model performance using only the training set 220, and without using the test set 225, such as by splitting the training set 220 into a number of groups (e.g., based on operator input that identifies the number of groups and/or based on randomly selecting a number of groups) and using those groups to estimate model performance. For example, using k-fold cross-validation, observations in the training set 220 may be split into k groups (e.g., in order or at random). For a training procedure, one group may be marked as a hold-out group, and the remaining groups may be marked as training groups. For the training procedure, the machine learning system may train a machine learning model on the training groups and then test the machine learning model on the hold-out group to generate a cross-validation score. The machine learning system may repeat this training procedure using different hold-out groups and different test groups to generate a cross-validation score for each training procedure. In some implementations, the machine learning system may independently train the machine learning model k times, with each individual group being used as a hold-out group once and being used as a training group k - 1 times. The machine learning system may combine the cross-validation scores for each training procedure to generate an overall cross-validation score for the machine learning model. The overall cross-validation score may include, for example, an average cross-validation score (e.g., across all training procedures), a standard deviation across cross-validation scores, or a standard error across cross-validation scores.

In some implementations, the machine learning system may perform cross-validation when training a machine learning model by splitting the training set into a number of groups (e.g., based on operator input that identifies the number of groups and/or based on randomly selecting a number of groups). The machine learning system may perform multiple training procedures and may generate a cross-validation score for each training procedure. The machine learning system may generate an overall cross-validation score for each hyperparameter set 240 associated with a particular machine learning algorithm. The machine learning system may compare the overall cross-validation scores for different hyperparameter sets 240 associated with the particular machine learning algorithm, and may select the hyperparameter set 240 with the best (e.g., highest accuracy, lowest error, or closest to a desired threshold) overall cross-validation score for training the machine learning model. The machine learning system may then train the machine learning model using the selected hyperparameter set 240, without cross-validation (e.g., using all of data in the training set 220 without any hold-out groups), to generate a single machine learning model for a particular machine learning algorithm. The machine learning system may then test this machine learning model using the test set 225 to generate a performance score, such as a mean squared error (e.g., for regression), a mean absolute error (e.g., for regression), or an area under receiver operating characteristic curve (e.g., for classification). If the machine learning model performs adequately (e.g., with a performance score that satisfies a threshold), then the machine learning system may store that machine learning model as a trained machine learning model 245 to be used to analyze new observations, as described below in connection with FIG. 3.

In some implementations, the machine learning system may perform cross-validation, as described above, for multiple machine learning algorithms (e.g., independently), such as a regularized regression algorithm, different types of regularized regression algorithms, a decision tree algorithm, or different types of decision tree algorithms. Based on performing cross-validation for multiple machine learning algorithms, the machine learning system may generate multiple machine learning models, where each machine learning model has the best overall cross-validation score for a corresponding machine learning algorithm. The machine learning system may then train each machine learning model using the entire training set 220 (e.g., without cross-validation), and may test each machine learning model using the test set 225 to generate a corresponding performance score for each machine learning model. The machine learning model may compare the performance scores for each machine learning model, and may select the machine learning model with the best (e.g., highest accuracy, lowest error, or closest to a desired threshold) performance score as the trained machine learning model 245.

As indicated above, FIG. 2 is provided as an example. Other examples may differ from what is described in connection with FIG. 2. For example, the machine learning model may be trained using a different process than what is described in connection with FIG. 2. Additionally, or alternatively, the machine learning model may employ a different machine learning algorithm than what is described in connection with FIG. 2, such as a Bayesian estimation algorithm, a k-nearest neighbor algorithm, an a priori algorithm, a k-means algorithm, a support vector machine algorithm, a neural network algorithm (e.g., a convolutional neural network algorithm), and/or a deep learning algorithm.

FIG. 3 is a diagram illustrating an example 300 of applying a trained machine learning model to a new observation associated with data labeling for training machine learning predictive models. The new observation may be input to a machine learning system that stores a trained machine learning model 305. In some implementations, the trained machine learning model 305 may be the trained machine learning model 245 described above in connection with FIG. 2. The machine learning system may include or may be included in a computing device, a server, or a cloud computing environment, such as the data labeling system and/or the machine learning system shown in FIGS. 1A-1B, as described in more detail elsewhere herein.

As shown by reference number 310, the machine learning system may receive a new observation (or a set of new observations), and may input the new observation to the machine learning model 305. As shown, the new observation may include a first feature of text (e.g., “444-55-6666”, a second feature of delimiter (e.g., “-”), a third feature of length (e.g., 9 digits), and so on, as an example. The machine learning system may apply the trained machine learning model 305 to the new observation to generate an output (e.g., a result). The type of output may depend on the type of machine learning model and/or the type of machine learning task being performed. For example, the output may include a predicted (e.g., estimated) value of target variable (e.g., a value within a continuous range of values, a discrete value, a label, a class, or a classification), such as when supervised learning is employed. Additionally, or alternatively, the output may include information that identifies a cluster to which the new observation belongs and/or information that indicates a degree of similarity between the new observation and one or more prior observations (e.g., which may have previously been new observations input to the machine learning model and/or observations used to train the machine learning model), such as when unsupervised learning is employed.

In some implementations, the trained machine learning model 305 may predict a value of SSN for the target variable of label for the new observation, as shown by reference number 315. Based on this prediction (e.g., based on the value having a particular label or classification or based on the value satisfying or failing to satisfy a threshold), the machine learning system may provide a recommendation and/or output for determination of a recommendation, such as masking, deleting, concealing, or otherwise obfuscating the text associated with the observation in one or more data sources. Additionally, or alternatively, the machine learning system may perform an automated action and/or may cause an automated action to be performed (e.g., by instructing another device to perform the automated action), such as masking the text in one or more data sources. As another example, if the machine learning system were to predict a value of phone number for the target variable of label, then the machine learning system may provide a different recommendation (e.g., do not mask the text) and/or may perform or cause performance of a different automated action. In some implementations, the recommendation and/or the automated action may be based on the target variable value having a particular label (e.g., classification or categorization) and/or may be based on whether the target variable value satisfies one or more thresholds (e.g., whether the target variable value is greater than a threshold, is less than a threshold, is equal to a threshold, or falls within a range of threshold values).

In some implementations, the trained machine learning model 305 may classify (e.g., cluster) the new observation in a cluster, as shown by reference number 320. The observations within a cluster may have a threshold degree of similarity. As an example, if the machine learning system classifies the new observation in a first cluster (e.g., addresses), then the machine learning system may provide a first recommendation, such as preserving the text with no masking. Additionally, or alternatively, the machine learning system may perform a first automated action and/or may cause a first automated action to be performed (e.g., by instructing another device to perform the automated action) based on classifying the new observation in the first cluster. As another example, if the machine learning system were to classify the new observation in a second cluster (e.g., SSNs), then the machine learning system may provide a second (e.g., different) recommendation (e.g., mask the text formatted as an SSN) and/or may perform or cause performance of a second (e.g., different) automated action, such as replacing the numbers in the text string with “X”s or other suitable characters. The recommendations, actions, and clusters described above are provided as examples, and other examples may differ from what is described above.

In this way, the machine learning system may apply a rigorous and automated process to accelerate data labeling using automated data profiling to generate labeled datasets that can be used to train one or more machine learning predictive models. The machine learning system enables recognition and/or identification of tens, hundreds, thousands, or millions of features and/or feature values for tens, hundreds, thousands, or millions of observations, thereby increasing accuracy and consistency and reducing delay associated with generating labeled datasets relative to requiring computing resources to be allocated for tens, hundreds, or thousands of operators to manually label data samples using the features or feature values.

As indicated above, FIG. 3 is provided as an example. Other examples may differ from what is described in connection with FIG. 3.

FIG. 4 is a diagram of an example environment 400 in which systems and/or methods described herein may be implemented. As shown in FIG. 4, environment 400 may include a data labeling system 410, a data source 420, a machine learning system 430, and a network 440. Devices of environment 400 may interconnect via wired connections, wireless connections, or a combination of wired and wireless connections.

The data labeling system 410 includes one or more devices capable of receiving, generating, storing, processing, providing, and/or routing information associated with accelerated data labeling with automated data profiling for training machine learning predictive models, as described elsewhere herein. The data labeling system 410 may include a communication device and/or a computing device. For example, the data labeling system 410 may include a server, such as an application server, a client server, a web server, a database server, a host server, a proxy server, a virtual server (e.g., executing on computing hardware), or a server in a cloud computing system. In some implementations, the data labeling system 410 includes computing hardware used in a cloud computing environment. In some implementations, the data labeling system 410 may include, may interact with, or may communicate with a client device, which may include a communication device and/or a computing device that enables a user to input one or more manual data labels to unlabeled data samples and/or enables the user to manage one or more automated labels that are applied to unlabeled data samples by the data labeling system 410. For example, the client device may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device.

The data source 420 includes one or more devices capable of receiving, generating, storing, processing, and/or providing information associated with data samples that are manually and/or automatically labeled to accelerate data labeling for training machine learning predictive models, as described elsewhere herein. The data source 420 may include a communication device and/or a computing device. For example, the data source 420 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The data source 420 may communicate with one or more other devices of environment 400, as described elsewhere herein.

The machine learning system 430 includes one or more devices capable of receiving, generating, storing, processing, providing, and/or routing information associated with training machine learning predictive models using one or more labeled datasets that are generated by the data labeling system 410 using accelerated data labeling techniques based on automated data profiling, as described elsewhere herein. The machine learning system 430 may include a communication device and/or a computing device. For example, the machine learning system 430 may include a server, such as an application server, a client server, a web server, a database server, a host server, a proxy server, a virtual server (e.g., executing on computing hardware), or a server in a cloud computing system. In some implementations, the machine learning system 430 includes computing hardware used in a cloud computing environment.

The network 440 includes one or more wired and/or wireless networks. For example, the network 440 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 440 enables communication among the devices of environment 400.

The number and arrangement of devices and networks shown in FIG. 4 are provided as an example. In practice, there may be additional devices and/or networks, fewer devices and/or networks, different devices and/or networks, or differently arranged devices and/or networks than those shown in FIG. 4. Furthermore, two or more devices shown in FIG. 4 may be implemented within a single device, or a single device shown in FIG. 4 may be implemented as multiple, distributed devices. Additionally, or alternatively, a set of devices (e.g., one or more devices) of environment 400 may perform one or more functions described as being performed by another set of devices of environment 400.

FIG. 5 is a diagram of example components of a device 500, which may correspond to data labeling system 410, data source 420, and/or machine learning system 430. In some implementations, data labeling system 410, data source 420, and/or machine learning system 430 include one or more devices 500 and/or one or more components of device 500. As shown in FIG. 5, device 500 may include a bus 510, a processor 520, a memory 530, an input component 540, an output component 550, and a communication component 560.

Bus 510 includes one or more components that enable wired and/or wireless communication among the components of device 500. Bus 510 may couple together two or more components of FIG. 5, such as via operative coupling, communicative coupling, electronic coupling, and/or electric coupling. Processor 520 includes a central processing unit, a graphics processing unit, a microprocessor, a controller, a microcontroller, a digital signal processor, a field-programmable gate array, an application-specific integrated circuit, and/or another type of processing component. Processor 520 is implemented in hardware, firmware, or a combination of hardware and software. In some implementations, processor 520 includes one or more processors capable of being programmed to perform one or more operations or processes described elsewhere herein.

Memory 530 includes volatile and/or nonvolatile memory. For example, memory 530 may include random access memory (RAM), read only memory (ROM), a hard disk drive, and/or another type of memory (e.g., a flash memory, a magnetic memory, and/or an optical memory). Memory 530 may include internal memory (e.g., RAM, ROM, or a hard disk drive) and/or removable memory (e.g., removable via a universal serial bus connection). Memory 530 may be a non-transitory computer-readable medium. Memory 530 stores information, instructions, and/or software (e.g., one or more software applications) related to the operation of device 500. In some implementations, memory 530 includes one or more memories that are coupled to one or more processors (e.g., processor 520), such as via bus 510.

Input component 540 enables device 500 to receive input, such as user input and/or sensed input. For example, input component 540 may include a touch screen, a keyboard, a keypad, a mouse, a button, a microphone, a switch, a sensor, a global positioning system sensor, an accelerometer, a gyroscope, and/or an actuator. Output component 550 enables device 500 to provide output, such as via a display, a speaker, and/or a light-emitting diode. Communication component 560 enables device 500 to communicate with other devices via a wired connection and/or a wireless connection. For example, communication component 560 may include a receiver, a transmitter, a transceiver, a modem, a network interface card, and/or an antenna.

Device 500 may perform one or more operations or processes described herein. For example, a non-transitory computer-readable medium (e.g., memory 530) may store a set of instructions (e.g., one or more instructions or code) for execution by processor 520. Processor 520 may execute the set of instructions to perform one or more operations or processes described herein. In some implementations, execution of the set of instructions, by one or more processors 520, causes the one or more processors 520 and/or the device 500 to perform one or more operations or processes described herein. In some implementations, hardwired circuitry is used instead of or in combination with the instructions to perform one or more operations or processes described herein. Additionally, or alternatively, processor 520 may be configured to perform one or more operations or processes described herein. Thus, implementations described herein are not limited to any specific combination of hardware circuitry and software.

The number and arrangement of components shown in FIG. 5 are provided as an example. Device 500 may include additional components, fewer components, different components, or differently arranged components than those shown in FIG. 5. Additionally, or alternatively, a set of components (e.g., one or more components) of device 500 may perform one or more functions described as being performed by another set of components of device 500.

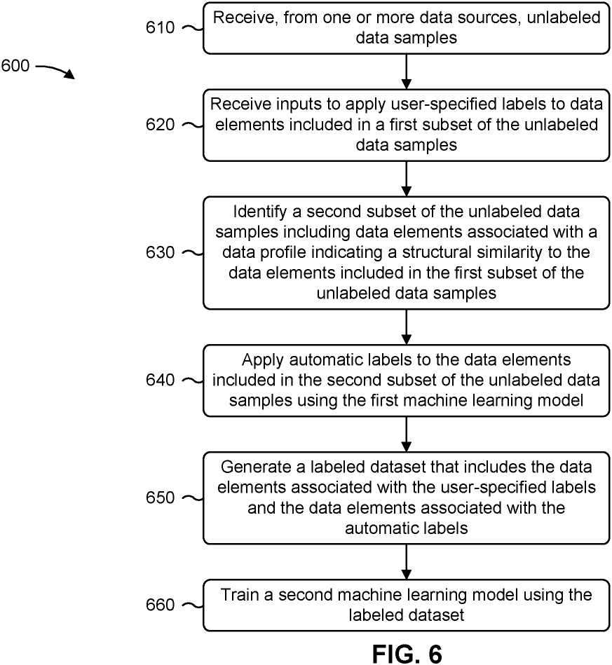

FIG. 6 is a flowchart of an example process 600 associated with accelerated data labeling with automated data profiling for training machine learning predictive models. In some implementations, one or more process blocks of FIG. 6 may be performed by a data labeling system (e.g., data labeling system 410). In some implementations, one or more process blocks of FIG. 6 may be performed by another device or a group of devices separate from or including the data labeling system, such as data source 420 and/or machine learning system 430. Additionally, or alternatively, one or more process blocks of FIG. 6 may be performed by one or more components of device 500, such as processor 520, memory 530, input component 540, output component 550, and/or communication component 560.

As shown in FIG. 6, process 600 may include receiving, from one or more data sources, unlabeled data samples (block 610). As further shown in FIG. 6, process 600 may include receiving inputs to apply user-specified labels to data elements included in a first subset of the unlabeled data samples (block 620). As further shown in FIG. 6, process 600 may include identifying a second subset of the unlabeled data samples including data elements associated with a data profile indicating a structural similarity to the data elements included in the first subset of the unlabeled data samples (block 630). In some implementations, the second subset of the unlabeled data samples is identified using a first machine learning model that is trained using a training dataset and a test dataset that are based on the user-specified labels. As further shown in FIG. 6, process 600 may include applying automatic labels to the data elements included in the second subset of the unlabeled data samples using the first machine learning model (block 640). As further shown in FIG. 6, process 600 may include generating a labeled dataset that includes the data elements associated with the user-specified labels and the data elements associated with the automatic labels (block 650). As further shown in FIG. 6, process 600 may include training a second machine learning model using the labeled dataset (block 660).

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel. The process 600 is an example of one process that may be performed by one or more devices described herein. The one or more devices may perform one or more other processes based on operations described herein, such as the operations described in connection with FIGS. 1A-1B, FIG. 2, and/or FIG. 3.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code - it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for generating labeled datasets for training machine learning models, the system comprising:
one or more memories; and
one or more processors, communicatively coupled to the one or more memories, configured to:
receive, from one or more data sources, unlabeled data samples;
receive inputs to apply user-specified labels to data elements included in a first subset of the unlabeled data samples;
identify a second subset of the unlabeled data samples including data elements associated with a data profile indicating a structural similarity to the data elements included in the first subset of the unlabeled data samples,
wherein the second subset of the unlabeled data samples is identified using a first machine learning model that is trained using a training dataset and a test dataset that are based on the user-specified labels;
apply automatic labels to the data elements included in the second subset of the unlabeled data samples using the first machine learning model;
generate a labeled dataset that includes the data elements associated with the user-specified labels and the data elements associated with the automatic labels; and
train a second machine learning model using the labeled dataset.

2. The system of claim 1, wherein the one or more processors, to identify the second subset of the unlabeled data samples, are configured to:
detect one or more attributes related to a structure associated with the data elements included in the first subset of the unlabeled data samples,
wherein the second subset of the unlabeled data samples is identified based on the data profile indicating the structural similarity to the one or more attributes associated with the data elements included in the first subset of the unlabeled data samples.

3. The system of claim 1, wherein the one or more processors are further configured to:
determine a confidence level associated with the automatic label applied to each data element included in the second subset of the unlabeled data samples.

4. The system of claim 3, wherein the one or more processors are further configured to:
identify, among the automatic labels applied to the data elements included in the second subset of the unlabeled data samples, a subset of the automatic labels for which the associated confidence level satisfies a threshold; and
maintain, in the labeled dataset, the subset of the automatic labels for which the associated confidence level satisfies the threshold without informing one or more users.

5. The system of claim 3, wherein the one or more processors are further configured to:
identify, among the automatic labels applied to the data elements included in the second subset of the unlabeled data samples, a subset of the automatic labels for which the associated confidence level fails to satisfy a threshold; and
present a user interface to request feedback related to the subset of the automatic labels for which the associated confidence level fails to satisfy the threshold.

6. The system of claim 5, wherein the user interface includes one or more visual indicators to differentiate the automatic labels for which the feedback is requested.

7. The system of claim 5, wherein the one or more processors are further configured to:
receive, via the user interface, feedback confirming the subset of the automatic labels for which the associated confidence level fails to satisfy the threshold;
maintain, in the labeled dataset, the subset of the automatic labels based on the feedback confirming the subset of the automatic labels; and
reinforce one or more rules used by the first machine learning model to predict the subset of the automatic labels based on the feedback confirming the subset of the automatic labels.

8. The system of claim 5, wherein the one or more processors are further configured to:
receive, via the user interface, feedback rejecting or modifying the subset of the automatic labels for which the associated confidence level fails to satisfy the threshold;
modify, in the labeled dataset, the subset of the automatic labels based on the feedback rejecting or modifying the subset of the automatic labels; and
update one or more counter-rules used by the first machine learning model based on the feedback rejecting or modifying the subset of the automatic labels.

9. The system of claim 1, wherein the one or more processors are further configured to:
detect, in the one or more data sources, data elements that contain sensitive information using the second machine learning model,
wherein the second machine learning model is trained to predict whether a data element contains sensitive information using one or more of a training dataset or a test dataset created from the labeled dataset; and
conceal the sensitive information within the one or more data sources,
wherein the one or more processors, to conceal the sensitive information, are configured to mask or delete the sensitive information in the one or more data sources.

10. A method for generating a labeled dataset using automated data profiling, comprising:
receiving, by a data labeling system, unlabeled data samples;
receiving, by the data labeling system, inputs to apply user-specified labels to data elements included in a first subset of the unlabeled data samples;
identifying, by the data labeling system, a second subset of the unlabeled data samples including data elements associated with a data profile indicating a structural similarity to the data elements included in the first subset of the unlabeled data samples,
wherein the second subset of the unlabeled data samples is identified using a first machine learning model that is trained based on the user-specified labels;
applying, by the data labeling system, automatic labels to the data elements included in the second subset of the unlabeled data samples using the first machine learning model; and
generating, by the data labeling system, a labeled dataset that includes the data elements associated with the user-specified labels and the data elements associated with the automatic labels.

11. The method of claim 10, wherein identifying the second subset of the unlabeled data samples comprises:
detecting one or more attributes related to a structure associated with the data elements included in the first subset of the unlabeled data samples,
wherein the second subset of the unlabeled data samples is identified based on the data profile indicating the structural similarity to the one or more attributes associated with the data elements included in the first subset of the unlabeled data samples.

12. The method of claim 10, further comprising:
determining a confidence level associated with the automatic label applied to each data element included in the second subset of the unlabeled data samples.

13. The method of claim 12, further comprising:
identifying, among the automatic labels applied to the data elements included in the second subset of the unlabeled data samples, a subset of the automatic labels for which the associated confidence level satisfies a threshold; and
maintaining, in the labeled dataset, the subset of the automatic labels for which the associated confidence level satisfies the threshold without informing one or more users.

14. The method of claim 12, further comprising:
identifying, among the automatic labels applied to the data elements included in the second subset of the unlabeled data samples, a subset of the automatic labels for which the associated confidence level fails to satisfy a threshold; and
presenting a user interface to request feedback related to the subset of the automatic labels for which the associated confidence level fails to satisfy the threshold.

15. The method of claim 14, further comprising:
receiving, via the user interface, feedback confirming the subset of the automatic labels for which the associated confidence level fails to satisfy the threshold;
maintaining, in the labeled dataset, the subset of the automatic labels based on the feedback confirming the subset of the automatic labels; and
reinforcing one or more rules used by the first machine learning model to predict the subset of the automatic labels based on the feedback confirming the subset of the automatic labels.

16. The method of claim 14, further comprising:
receiving, via the user interface, feedback rejecting or modifying the subset of the automatic labels for which the associated confidence level fails to satisfy the threshold;
modifying, in the labeled dataset, the subset of the automatic labels based on the feedback rejecting or modifying the subset of the automatic labels; and
updating one or more counter-rules used by the first machine learning model based on the feedback rejecting or modifying the subset of the automatic labels.

17. A non-transitory computer-readable medium storing a set of instructions, the set of instructions comprising:
one or more instructions that, when executed by one or more processors of a data labeling system, cause the data labeling system to:
receive, from one or more data sources, unlabeled data samples;
receive inputs to apply user-specified labels to data elements included in a first subset of the unlabeled data samples;
identify a second subset of the unlabeled data samples including data elements associated with a data profile indicating a structural similarity to the data elements included in the first subset of the unlabeled data samples,
wherein the second subset of the unlabeled data samples is identified using a first machine learning model that is trained using a training dataset and a test dataset that are based on the user-specified labels;
apply automatic labels to the data elements included in the second subset of the unlabeled data samples using the first machine learning model;
present a user interface to request feedback related to the automatic labels based on confidence levels associated with the automatic labels; and
generate, based on the feedback related to the automatic labels, a labeled dataset that includes the data elements associated with the user-specified labels and the data elements associated with the automatic labels.

18. The non-transitory computer-readable medium of claim 17, wherein the one or more instructions further cause the data labeling system to:
identify, among the automatic labels applied to the data elements included in the second subset of the unlabeled data samples, a subset of the automatic labels for which the associated confidence level satisfies a threshold; and
maintain, in the labeled dataset, the subset of the automatic labels for which the associated confidence level satisfies the threshold without requesting feedback via the user interface.

19. The non-transitory computer-readable medium of claim 17, wherein the one or more instructions further cause the data labeling system to:
receive, via the user interface, feedback confirming a subset of the automatic labels;
maintain, in the labeled dataset, the subset of the automatic labels based on the feedback confirming the subset of the automatic labels; and
reinforce one or more rules used by the first machine learning model to predict the subset of the automatic labels based on the feedback confirming the subset of the automatic labels.

20. The non-transitory computer-readable medium of claim 17, wherein the one or more instructions further cause the data labeling system to:
receive, via the user interface, feedback rejecting or modifying a subset of the automatic labels;
modify, in the labeled dataset, the subset of the automatic labels based on the feedback rejecting or modifying the subset of the automatic labels; and
update one or more counter-rules used by the first machine learning model based on the feedback rejecting or modifying the subset of the automatic labels.
